(19) United States
(12) Patent Application Publication
(10) Pub. No.: US 2007/0155905 A1
(43) Pub. Date: Jul. 5, 2007

(54) Polyolefin material with enhanced surface durability

(76) Inventors: Marta Drewniak, Carrollton, TX (US); Tara Thomasson, Burleson, TX (US)

Correspondence Address: WINSTON & STRAWN LLP;PATENT DEPARTMENT, 1700 K STREET, N.W., WASHINGTON, DC, 20006, US

(21) Appl. No.: 11/322,421

(22) Filed: Jan. 3, 2006

(51) Int. Cl. C08L 23/04

(52) U.S. Cl. 525/240

(57) ABSTRACT

Thermoplastic polyolefin blends with a good stiffness/impact balance, as well as enhanced surface durability, contain semi-crystalline polypropylene resin component, a propylene-based elastomer component, and an optional but preferred styrene-based elastomer component. The propylene-based elastomer (PBE) is characterized as having at least one of a) a plurality of identifying band positions at 998 cm⁻¹, 974 cm⁻¹, and 733 cm⁻¹, as measured by Fourier Transform Infrared Spectroscopy (FTIR); or one or more glass transition temperatures (Tg) from about −15° C. to −35° C., as measured by Differential Scanning Calorimetry. The surface of articles made from such a thermoplastic blend shows increased scratch resistance and a decrease in stress whitening.

### TECHNICAL FIELD

This invention relates generally to thermoplastic polyolefin blends which exhibit superior physical properties, such as a combination of stiffness, impact resistance, and scratch resistance with little or no stress whitening. The invention also relates to compositions containing such blends, molded or extruded articles using such blends, as well as to methods for producing compositions and articles using the same.

### BACKGROUND OF THE INVENTION

It is known that semi-crystalline polypropylene is excellent in rigidity, heat resistance, surface gloss, etc.; however, the impact resistance and elasticity of polypropylene alone is poor and, consequently, polypropylene is not suitable for applications requiring such properties. It is further known that the addition of ethylene-based elastomers will impart greater ductility and higher impact strength to the semi-crystalline polypropylene. Such an improvement in impact resistance, however, often has the unintended consequence of decreasing the stiffness and rigidity of these so-called thermoplastic elastomer (TPE) blends. TPEs are an important class of polymers and polymer blends that are particularly useful in producing durable components through injection molding or extrusion processes.

Along with the physical characteristics of stiffness and impact resistance, the surface of the molded article is typically required to maintain a good appearance and it is therefore desirable for aesthetic reasons for the thermoplastic polyolefin blends to exhibit minimal susceptibility to mechanically induced surface damage (e.g., good scratch resistance). U.S. Pat. No. 6,541,568 discloses that the addition of styrenic copolymers enhances the scratch resistance of polypropylene. Styrenic copolymers, however, are expensive to manufacture, and the addition of significant amounts of such copolymers can significantly increase the cost of the thermoplastic polyolefin blend.

Thermoplastic elastomer blends that combine semi-crystalline polypropylene resins with two or more elastomers are known in the art. Such a combination must be implemented carefully, however, since increasing the number of components in a polymeric blend also tends to increase the problem of stress whitening in articles made from such blends. Stress whitening of polymeric materials is aesthetically undesirable, because the white marks give a prominent contrast with the color of the article and therefore reduces the quality and the value of the product or renders it unacceptable to the end-user. A few examples of such multi-component blends are set forth below.

U.S. Pat. No. 5,750,612 discloses a blend comprising a crystalline propylene block copolymer obtained in a two-step polymerization with a so-called Ziegler-Natta catalyst, a hydrogenated block copolymer with a styrene content less than 22 weight percent, and a hydrogenated block copolymer with a styrene content greater than 27 weight percent. The propylene block copolymer has an ethylene content of 0.5 to 8 weight percent and an isotacticity of greater than 97%.

U.S. Pat. No. 6,245,856 discloses a composition containing polypropylene, an ethylene-based elastomer and 2 to 15 weight percent of a compatibilizer with a propylene content greater than 80 weight percent. U.S. Pat. No. 6,429,260 discloses a composition containing a polyolefin thermoplastic, a hydrogenated block copolymer of a vinyl aromatic and conjugated diene monomer having a level of aromatic hydrogenation of at least 70 percent and at least one linear or substantially linear ethylene/alpha-olefin polymer. The polyolefin thermoplastic component may be a blend of polypropylene and an ethylene/propylene copolymer.

Despite these prior art formulations, there remains a need to obtain thermoplastic polyolefin blends having the desired balance of good scratch resistance with little or no stress whitening, along with the physical property requirements of rigidity, strength, processability, and impact resistance.

### SUMMARY OF THE INVENTION

The invention relates to a thermoplastic polyolefin blend having a rigidity and impact strength, which includes a semi-crystalline polypropylene resin component in an amount sufficient to impart rigidity to the blend, and an elastomeric component in an amount sufficient to impart impact strength to the blend and which includes the combination of: a propylene-based elastomer component having at least one isotactic polypropylene sequence and being present in an amount of at least about 0.1 weight percent to less than 40 weight percent based on the total weight of polymers in the blend, and a styrene-based elastomer component present in an amount of at least about 0.1 weight percent of the blend.

In one embodiment, the at least one semi-crystalline polypropylene resin component is present in an amount from about 1 to 99 weight percent, and the elastomeric component is present in an amount from about 1 to 99 weight percent, each based on the total weight of the polymers present in the blend. In a preferred embodiment, the blend includes at least one semi-crystalline polypropylene resin component present in an amount from about 20 to 95 weight percent, and the elastomeric component present in an amount from about 5 to 80 weight percent, each based on the total weight of the polymers present in the blend.

In a preferred embodiment, the propylene-based elastomer component includes at least one of the following physical properties: a) a plurality of identifying band positions at about 998 cm⁻¹, 974 cm⁻¹, and 733 cm⁻¹, as measured by Fourier Transform Infrared Spectroscopy (FTIR); or b) one or more glass transition temperatures (Tg) from about −15° C. to −35° C., as measured by Differential Scanning Calorimetry (DSC). In a more preferred embodiment, the propylene-based elastomer component is a propylene/alpha-olefin copolymer or terpolymer with a propylene content of at least about 40 weight percent. In another more preferred embodiment, the propylene-based elastomer component is present in an amount of about 16 weight percent to 38 weight percent of the total weight of the polymers in the blend. In yet another more preferred embodiment, the propylene-based elastomer component has at least one of the following properties: a density typically ranging from about 0.858 to about 0.890 g/cm³, an overall crystallinity of about 3 to about 34%, or a weight average molecular weight (Mw) from about 50,000 to 400,000, or a combination thereof.

In another embodiment, the styrene-based elastomer component is in the form of a block or random styrene copolymer that includes a styrenic component and a hydrogenated or non-hydrogenated olefinic component. In a preferred embodiment, the styrene-based elastomer component is selectively hydrogenated, wherein at least about 80% of the double bonds in the hydrogenated olefinic component are hydrogenated, and wherein less than about 65% of the double bonds of the styrenic component are hydrogenated. In another preferred embodiment, the styrene-based elastomer component includes styrene-ethylene/butylene, styrene-ethylene/butylene-styrene, styrene-ethylene/propylene-styrene, styrene-butadiene, styrene-butadiene-styrene, styrene-butylene-styrene, styrene-butylene-butadiene-styrene, styrene-isoprene-styrene, or a blend thereof.

Yet another embodiment of the invention is one where the semi-crystalline polypropylene resin component includes one or more homopolymers of propylene, copolymers of at least 50 weight percent propylene and at least one other C₂ to C₂₀ alpha-olefin, or mixtures thereof, and is preferably present in an amount of between about 30 to 90 weight percent based on the total weight of the polymers present in the blend. In another embodiment, the blend further includes a high density polyethylene or low density polyethylene that is present in an amount sufficient to enhance the toughness of the blend and up to about 25 weight percent of the total weight of polymers in the blend. In other embodiments, the blend further includes one or more thermal stabilizers, ultraviolet stabilizers, flame retardants, mineral fillers, process oils, conductive fillers, nucleating agents, plasticizers, impact modifiers, colorants, mold release agents, lubricants, antistatic agents, pigments, or a combination thereof.

In one preferred embodiment, the propylene-based elastomer component is present in an amount greater than 15 weight percent of the total weight of the polymers present in the overall blend, and the styrene-based elastomer component is present in an amount of less than 75 weight percent of the total weight of the polymers present in the overall blend. In another preferred embodiment, the styrene-based elastomer component has at least one glass transition temperature (Tg) from about −40° C. to −60° C., as measured by DSC, while in yet another the semi-crystalline polypropylene resin component has at least one glass transition temperature from about −10° C. to about 5° C., as measured by DSC.

The invention also encompasses molded articles or extruded articles formed from or including any of the blends described herein.

### DETAILED DESCRIPTION OF THE PREFERRED EMBODIMENTS

In accordance with this invention, it has now been found that a thermoplastic blend exhibiting a superior balance of stiffness, impact resistance, and scratch resistance with little or no stress whitening may be obtained from combining a sufficient amount of a semi-crystalline polypropylene resin component to increase the rigidity of the composition, and a sufficient amount of an elastomeric component to increase the impact strength of the blend. The elastomeric component includes about 0.1 up to 40 weight percent of a propylene-based elastomer component that can substitute for a portion of the styrene-based elastomer materials in a polymer blend, e.g., SEBS, particularly when present in amounts below 40 weight percent. The propylene-based elastomer can typically provide improved material characteristics or other advantages in processing or performance of the resultant thermoplastic blend. The elastomeric component preferably also includes at least about 0.1 percent of a styrene-based elastomer component.

The semi-crystalline polypropylene resin component is typically present in an amount of about 1 to 99 weight percent, preferably from about 20 to 95 weight percent, and more preferably from about 30 to 90 weight percent, based on the total weight of the polymers present in the blend. The semi-crystalline polypropylene resin component is typically chosen from one or more of: homopolymers of propylene, copolymers of at least 50 weight percent propylene and at least one other C₂ to C₂₀ alpha-olefin, or mixtures thereof. Copolymers of propylene, if used, may preferably include a random copolymer or an impact block copolymer (i.e., a block copolymer composed of propylene polymer units and ethylene/propylene copolymer units). Preferred alpha-olefins for such copolymers include ethylene, 1-butene, 1-pentene, 1-hexene, methyl-1-butenes, methyl-1-pentenes, 1-octene, 1-decene, or combinations thereof.

“Semi-crystalline,” as used herein, typically means that the crystallinity is at least about 40%, preferably at least about 55%, and more preferably at least about 80%. Moreover, the semi-crystalline polypropylene resin has a typical melt flow rate (as determined by ASTM D-1238-01 at a temperature of 230° C. and at a load of 2.16 kg) of about 0.001 dg/min to 500 dg/min, preferably about 0.01 to 250 dg/min, and more preferably about 0.1 to 150 dg/min. Preferably, the semi-crystalline polypropylene component is further characterized by a density typically ranging from about 0.897 g/cm³ to about 0.925 g/cm³. A preferred density of the semi-crystalline polypropylene component is from about 0.9 g/cm³ to 0.925 g/cm³. The weight average molecular weight (Mw) of the semi-crystalline polypropylene component is typically from about 85,000 to 900,000, preferably from 90,000 to less than 800,000, and more preferably from about 95,000 to 760,000. The semi-crystalline polypropylene may be grafted or ungrafted. In one embodiment, the semi-crystalline polypropylene resin is at least substantially, or entirely, free of grafted functional groups.

Exemplary semi-crystalline polypropylene homopolymers or copolymers according to the invention includes those that are commercially available as, for example, PROFAX from Basell North America, Inc. of Wilmington, Del. and as various types of polypropylene homopolymers and copolymers from ExxonMobil Chemicals Company of Houston, Tex., from Sunoco Chemicals of Pittsburgh, Pa., from Innovene LLC of Chicago, Ill., and from Dow Chemical Company of Midland, Mich.

The elastomeric component of the invention is typically present in an amount of about 1 to 99 weight percent, preferably from about 1 to 70 weight percent, and more preferably from about 1 to 55 weight percent, based on the total weight of the polymers present in the blend. The elastomeric component includes at least one propylene-based elastomer (PBE). Although lower amounts are suitable, preferably at least about 25 percent of the total amount of the elastomeric component is composed of the propylene-based elastomer, which is characterized as having at least one of the following physical properties:

a) Identifying band positions at 998 cm⁻¹, 974 cm⁻¹, and 733 cm⁻¹, as measured by Fourier Transform Infrared Spectroscopy (FTIR); or

b) one or more glass transition temperatures (Tg) from −15° C. to −35° C., as measured by Differential Scanning Calorimetry.

Fourier Transform Infra-Red spectroscopy (FTIR), which corresponds to the vibrational energies of atoms or specific groups of atoms within a molecule, as well as rotational energies, identifies components by comparing the infrared spectra of a sample to reference spectra, as described in ASTM E168-99 (2004). Infrared radiation in the range from about 10,000 ⁻¹ cm to 100 cm⁻¹ can be absorbed and converted by a molecule into an energy of molecular vibration. Although the infrared spectrum is characteristic of the entire molecule, certain groups of atoms give rise to bands at or near the same frequency regardless of the structure of the rest of the molecule. Vibrational spectra appear as bands rather than as lines because a single vibrational energy change can be accompanied by a number of rotational energy changes. It is the persistence of these characteristic bands that permits the practitioner to obtain useful structural information by simple inspection and reference to generalized charts of characteristic group frequencies. Band positions in infrared spectra are presented either as wavenumbers or wavelengths and are understood to be equivalent. The wavenumber unit (cm⁻¹, or reciprocal centimeters) is used most often because it is proportional to the energy of the vibration.

The propylene-based elastomer of the current invention is therefore characterized in one embodiment as presenting wavenumbers at the 998 cm⁻¹, 974 cm⁻¹, and 733 cm⁻¹ regions of the infrared spectra, as measured by the FTIR technique. Although additional bands are apparent on the infrared spectra of propylene-based elastomers, it is understood that the above mentioned regions correlate to pertinent molecular structures that are characteristic of the PBE component of the present invention. The 998 cm⁻¹ band position is associated with the threefold helix of isotactic polypropylene and is therefore a characteristic of crystalline polypropylene, while the 974 cm⁻¹ band position, which is associated with the methyl rocking vibrations, may be used as an internal standard to approximate the degree of propylene crystallinity. A crystalline PP ratio may thus be obtained by comparing the area under the peak at 998 cm⁻¹ to the area under the peak at 974 cm⁻¹. The propylene-based elastomer of the present invention is therefore characterized by a crystalline PP ratio ranging from about 0.0100 to 0.5005, preferably from about 0.0500 to 0.4501. In contrast, the crystalline PP ratio of a typical semi-crystalline polypropylene resin is approximately 0.8288. The two wavenumbers characteristic for polypropylene (i.e., 998 cm⁻¹ and 974 cm⁻¹) are absent from the infrared spectra of ethylene-based elastomers, such as ethylene-propylene copolymers, although it should be understood that ethylene can be included. If no crystalline polypropylene is present, these peaks are not expected to be present.

It is also well known that the region near the FTIR infrared spectra of 800 to 660 cm⁻¹, the so-called CH₂ rocking vibration, is shifted appreciably depending on the CH₂ sequence length. Ethylene-based elastomers, for example, present a band position at 720 cm⁻¹ due to the presence of long methylene sequence lengths (i.e., units of (—CH₂—CH₂—)ₙ where n>2). When included, preferred ethylene-based elastomers typically have an elongation of about 600% to 1300%. Such ethylene-based elastomers can also have a density of about 0.86 g/cm³ to 0.91 g/cm3. Propylene-based elastomers, on the other hand, present a band position at 733 cm⁻¹ due to the insertion of an isolated ethylene unit (i.e., units of (—CH₂—CH₂—)ₙ where n=1) in the propylene backbone. Due to possible irregularities in the head-to-tail sequences of the propylene monomers in the polymer backbone, the single ethylene unit may be inserted either between two propylene units or between one conventional (i.e., head-to-tail) propylene unit and one inverted (i.e., tail-to-head) propylene unit.

Differential Scanning Calorimetry (DSC) is a common technique that may be used to measure the glass transition temperature(s) (Tg) of semi-crystalline and amorphous polymers, as described in ASTM E1356-04. The glass transition temperature may be defined as the temperature below which molecular segment rotations do not occur within the experimental time scale. The DSC technique involves continuously monitoring the difference in heat flow into, or temperature between, a reference material and a test material when the materials are heated or cooled at a controlled rate through the glass transition region of the test material. The glass transition is a second-order transition and may be interpreted as the onset of long-range, coordinated molecular motion. Tg is therefore influenced by the chemical structure of the polymer and typically increases when chain mobility is reduced.

The glass transition temperature of the propylene-based elastomer of the present invention typically ranges from about −15° C. to about −35° C. In contrast, the Tg of ethylene-based elastomers (i.e., plastomers, ethylene/alpha-olefin copolymers or substantially linear ethylene/alpha-olefin interpolymers) and styrene-based elastomers used in connection with the invention typically ranges from about −40° C. to −60° C., while the glass transition temperature of semi-crystalline polypropylene resins used in connection with the invention typically ranges from about −10° C. to about 5° C.

The propylene-based elastomer component is a propylene/alpha-olefin copolymer or terpolymer with a propylene content of at least about 40 weight percent, preferably of at least 50 weight percent to 99.9 weight percent, and more preferably from about 75 to 97 weight percent. The propylene-based elastomer additionally preferably contains at least about 0.1 weight percent of the above described alpha-olefins (i.e., ethylene, butene, hexene, etc.), preferably at least about 5 weight percent based on the polymers in the PBE. In one embodiment, the propylene-based elastomer is present in less than 40 weight percent of the total weight of the polymers present in the overall blend, preferably ranging from about 2 to 38 weight percent, and more preferably from about 16 to 38 weight percent. Other preferred amounts of propylene-based elastomer include about 3 to 35 weight percent, and about 5 to 30 weight percent. The propylene-based elastomer is further characterized by a density typically ranging from about 0.858 to about 0.89 g/cm^{3,} by an overall crystallinity of from about 3 to about 34%, and by a weight average molecular weight (Mw) from about 50,000 to 400,000, preferably from 70,000 to less than 350,000, and more preferably from about 75,000 to 300,000. An exemplary Mw of PBE is about 100,000.

In addition, the elasticity of the propylene-based elastomer component differentiates this class of propylene-containing compounds from the semicrystalline polypropylene resins described above. Elasticity is defined as the ability of a polymer to retract to its original dimensions upon removal of the expansive force and is typically reported as a percentage of elongation (as determined by ISO 527-2 (1993) at a test speed of 50 mm/min). The elongation % of the PBE component typically ranges from about 100 to about 1500%, while the elongation % of semicrystalline polypropylene resins is typically less than 75% (i.e., such semicrystalline polymers undergo irreversible deformation during uniaxial tensile elongation). The inelastic nature of semicrystalline polypropylene resins is further illustrated by impact block copolymers such as Sunoco Chemicals' TI-5600-M with a density of 0.903 g/cm³ and an elongation at yield of 5% and by propylene random copolymers such as Dow Chemical Company's 6D75K with a density of 0.9 g/cm³ and an elongation at yield of 9%.

Generally, without limitation of the scope of the invention, one means for preparing the propylene-based elastomer component useful in this invention is as follows: (1) propylene and an alpha-olefin are introduced into a stirred tank reactor, (2) the catalyst system is introduced via nozzles, (3) solvent is fed to the reactor, (4) the reactor contains a liquid phase composed of propylene, together with alpha-olefin, solvent and polymer, (5) the reactor temperature and pressure may be controlled via autorefrigeration, as well as by cooling coils, jackets, feed regulation, etc., (6) the polymerization rate is controlled by the concentration of catalysts, monomer and temperature, and (7) the alpha-olefin content of the polymer product is determined by the ratio of alpha-olefin to propylene in the reactor, which is controlled by manipulating the feed rates of these components into the reactor. Illustrative of possible so-called Kaminsky, metallocene, constrained geometry, metal centered/heteroaryl ligand and other single-site catalysts that may be used in the manufacture of the propylene-based elastomers of this invention are described in U.S. Pat. No. 5,324,800, U.S. Publication No. 2004-249084, and U.S. Publication No. 2005-107534, the disclosures of which are hereby incorporated by express reference thereto. It is understood by those of ordinary skill in the art that the propylene-based elastomers of the present invention are intended to include any propylene-based elastomer exhibiting the properties described above and claimed herein. It is further understood that the unique characteristics of propylene-based elastomers (i.e., the combination of propylene crystallinity and single insertion of an ethylene unit into the polymer backbone) may be difficult to produce using the multi-site Ziegler-Natta catalysts due to poor control of the polymer chain architecture and should therefore be polymerized with non-Ziegler-Natta catalysts (i.e., Kaminsky, metallocene, constrained geometry, metal centered/heteroaryl ligand and other single-site catalysts) above described and characterized as having a single, stable chemical site for polymerization.

While the process used to prepare the propylene-based elastomer component includes using a metallocene, constrained geometry, metal centered/heteroaryl ligand, organometallic, or other single-site catalyst in the liquid phase (slurry, solution, suspension, bulk phase, or combination thereof), according to other embodiments, high pressure fluid phase or gas phase polymerization processes may also be used. Such catalyst systems can also include other well-known additives such as, for example, activators, co-catalysts, and scavengers. These processes may be employed without limitation on the type of reaction vessels and the mode of conducting the polymerization.

Exemplary propylene-based elastomers according to the invention includes those that are commercially available as, for example, VISTAMAXX from ExxonMobil Chemicals Company of Houston, Tex. and VERSIFY from Dow Chemical Company of Midland, Mich.

The elastomeric component may optionally, but preferably, contain at least one styrene-based elastomer, which is a term used to designate an elastomer having at least one styrenic block component in combination with a saturated or unsaturated conjugated diene block component. The at least one styrene-based elastomer is present in an amount of less than 75 weight percent of the total weight of the polymers present in the overall blend, preferably ranging from about 0.001 to 70 weight percent, and more preferably from about 1 to 60 weight percent. In one embodiment, the elastomeric component of the thermoplastic olefin blend comprises at least one propylene-based elastomer present in an amount greater than 15 weight percent of the total weight of the polymers present in the overall blend and at least one styrene-based elastomer present in an amount less than about 75 weight percent of the total weight of the polymers present in the overall blend. U.S. Pat. No. 6,541,568, the teachings of which are hereby incorporated by express reference thereto, discloses styrenic-based materials suitable for inclusion in the present blends. In one embodiment, the styrene-based elastomer includes more than one styrene block.

The structure of the styrene-based elastomer useful in the current invention can be of the linear or radial type, and preferably of the diblock or triblock type (i.e., styrenic block/conjugated diene block/styrenic block). The styrenic portion of the elastomer is preferably a polymer of styrene and its analogs and homologs, including alpha-methylstyrene, and ring-substituted styrenes, particularly ring-methylated styrenes. The preferred styrenics are styrene and alpha-methylstyrene, with styrene being especially preferred. The styrene content of the styrene-based elastomer typically ranges from about 4 to 90 weight percent, preferably from about 6 to 75 weight percent, and more preferably from about 9 to 45 weight percent. The hydrogenated or non-hydrogenated conjugated diene component of the styrene-based elastomer may be butylene, butadiene, isoprene, propylene, or a combination thereof.

In one embodiment, the triblock form of the styrene-based elastomer contains at least one hydrogenated or non-hydrogenated conjugated diene block component and is preferably styrene-butadiene-styrene, styrene-butylene-butadiene-styrene, styrene-ethylene-butylene-styrene, styrene-isoprene-styrene, styrene-ethylene-propylene-styrene, styrene-ethylene-propylene-styrene-styrene-ethylene-propylene-styrene, or styrene-ethylene-ethylene-propylene-styrene, or combinations thereof. In a preferred embodiment, the styrene-based elastomer is a triblock type containing at least one hydrogenated butadiene block component in the form of styrene block-hydrogenated butadiene block-styrene block. In another embodiment, the conjugated diene component is hydrogenated butadiene, and crystalline polyethylene is used in place of at least one of the styrene block components.

If hydrogenated triblock styrene-based elastomers are utilized, the hydrogenation is preferably selective such that at least about 80% of the double bonds in the conjugated diene component are hydrogenated. With hydrogenated triblock styrene-based elastomers, typically no more than about 65% of the double bonds of the styrenic portion are hydrogenated, preferably no more than about 50%, and more preferably no more than about 35% of the double bonds of the styrenic portion are hydrogenated. In an exemplary embodiment, no more than about 20% of the double bonds of the styrenic portion are hydrogenated. A possible method for the selective hydrogenation of styrene-based elastomers is disclosed in, for example, U.S. Pat. No. 3,595,942, which is incorporated herein by express reference thereto.

The styrene-based elastomer can also include an hydrogenated styrene butadiene random copolymer alone or in combination with the styrene-based elastomers discussed above. In one embodiment, the polyolefin material of the present invention is essentially free of ethylene-based elastomers, plastomers, ethylene/alpha-olefin copolymers, or substantially linear ethylene/alpha-olefin interpolymers, or any combination thereof.

Exemplary styrene-based elastomers are commercially available as TUFTEC from Asahi America Inc. of Malden, Mass., as SEPTON from Kuraray Company, Ltd. Of Tokyo, Japan, as KRATON from Kraton Polymers of Houston, Tex., as K-RESIN from Phillips Petroleum Company, Inc., or as DYNARON from Japan Synthetic Resin of Tokyo, Japan.

Another component that may be present in the thermoplastic polyolefin blends of this invention is one or more polyethylene materials. Either high density polyethylene or low density polyethylene may be used. High density polyethylene is preferred. The melt index of the polyethylene component, when included, is typically from about 0.1 and 20. The polyethylene component, containing semi-crystalline homopolymers of ethylene, can be present in the blend in an amount of up to about 25 weight percent of the total weight of polymers in the blend, preferably from about 2 to 20 weight percent, and more preferably from about 5 to 18 weight percent.

A variety of conventional additives may also be optionally, but preferably, included in the compositions of the invention, including one or more thermal stabilizers, mineral fillers, ultraviolet stabilizers, antioxidants, foaming agents, waxes, flame retardants, dispersants, antistatic agents, lubricants, extender or process oils, nucleating agents, plasticizers, colorants, mold release agents, pigments, and the like, or combinations thereof.

Suitable mineral fillers include, but are not limited to, talc, ground calcium carbonate, precipitated calcium carbonate, precipitated silica, precipitated silicates, precipitated calcium silicates, pyrogenic silica, hydrated aluminum silicate, calcined aluminosilicate, clays, mica, wollastonite, and combinations thereof. When such optional mineral fillers are included, they can typically be present in amounts of about 1 to 40 weight percent, preferably in amounts of about 2 to 20 weight percent in one embodiment and in amounts of about 15 to 35 weight percent in another embodiment.

Melt blending is one suitable method for preparing the final polymer blend of the present invention, although any suitable polymer blending techniques available to those of ordinary skill in the art may be used. Techniques for melt blending of a polymer with additives of all types are known to those of ordinary skill the art and can typically be used with the present invention. In one type of melt blending operation useful with the present invention, the individual components of the blend are combined in a mechanical extruder or mixer, and then heated to a temperature sufficient to form a polymer melt.

The mechanical mixer can be a continuous or batch mixer. Examples of suitable continuous mixers include single screw extruders, intermeshing co-rotating twin screw extruders such as Werner & Pfleiderer ZSK™ extruders, counter-rotating twin screw extruders such as those manufactured by Leistritz™, and reciprocating single screw kneaders such as Buss™ co-kneaders. Examples of suitable batch mixers are lateral 2-roll mixers such as Banbury™ or Boling™ mixers. The temperature of the melt, residence time of the melt within the mixer, and the mechanical design of the mixer are several well known variables that control the amount of shear to be applied to the composition during mixing, and can be readily selected by one of ordinary skill in the art based on the disclosure of the invention herein.

The thermoplastic blend of the current invention may be pelletized via strand pelleting or commercial underwater pelletization. Pellets of the present composition may then be easily processed into shaped articles by injection molding, profile extrusion, blow molding, and other forming processes to give products which have well balanced properties in scratch resistance, stiffness and impact resistance. An exemplary blend is about 40 weight percent of crystalline-propylene resin component and about 60 weight percent elastomer component, of which at least about 15 weight percent but no more than 38 weight percent of the blend is propylene-based elastomer component.

In order to measure surface scratch resistance, the Ford Laboratory Test Method BN 108-13 “Resistance to Scratching” was modified for the requirements of the present invention. The apparatus uses a pneumatically driven sledge with five metal fingers (250 mm long). One end of each metal finger was fixed while the other end was supplied with an interchangeable scratch pin with a stainless steel tip (1.0 mm in diameter). The pins were loaded with different weights to exert standard forces on the surface of the test material. The loads were increased, as allowed in the Ford Laboratory Test Method, in order to meet the required scratch forces on the surface of the samples such that the loading forces, reported in Newtons (N), were 2, 5, 10, 15, and 20 N.

The test specimens were 100 mm×150 mm plaques conditioned at room temperature for more than 40 hours prior to testing. The test plaques were clamped under the five metal fingers of the apparatus which were then pneumatically drawn across the surface of the plaque at a constant velocity of approximately 100 mm per second. All tests were performed once for each plaque at room temperature. Upon completion of the test, the specimens were then evaluated visually on a numerical scale of 1 to 5 where:

| Scratch Rating | Description |
|---|---|
| 1 | No visible scratch |
| 1.5 | Gloss change without deformation |
| 2 | Slight deformation |
| 2.5 | Moderate deformation |
| 3 | Slight ribbing in scratch |
| 3.5 | Frequent ribbing |
| 4 | Continuous ribbing |
| 4.5 | Points of tearing |
| 5 | Continuous tearing |

Upon completion of the scratch evaluation, the test specimens were visually inspected for stress whitening; the results were reported as “A: little or no stress whitening visible;” “B: moderate stress whitening;” “C: severe stress whitening.” Stress whitening is herein defined as a change in the distribution of wavelength and intensity of reflected or scattered light due to structural inhomogeneities typically caused by crazes in the polymer matrix or by cavities in the elastomer phase (i.e., the formation of micro-voids ranging in size from several hundred nanometers to several microns).

The term “about,” as used herein, should generally be understood to refer to both numbers in a range of numerals. Moreover, all numerical ranges herein should be understood to include each whole integer within the range. When the term “weight percent” is used in reference to a polymer, it refers to the amount in weight percent of the polymer compared to the total amount of polymers in the blend or article.

“Essentially free” or “substantially free,” as used herein, refers to no more than about 5 percent, preferably no more than about 1 percent, and more preferably no more than about 0.5 percent of the characteristic referred to. In one preferred embodiment, “essentially free” or “substantially free” refers to less than 0.1 percent. These terms also encompass the absence of any detectable amount as well as the complete absence of the referenced characteristic.

All of the patents and other publications recited in the herein are incorporated herein by express reference thereto.

### EXAMPLES

The invention is further defined by reference to the following examples, describing the preparation of some thermoplastic blends of the present invention. It will be apparent to those of ordinary skill in the art that many modifications, both to materials and methods, may be practiced without departing from the purpose and intent of this invention based on the description herein. Thus, the following examples are offered by way of illustration, and not by way of limitation, to describe in greater detail certain methods for the preparation, treatment, and testing of some thermoplastic blends of the invention.

The significance of the symbols used in these examples, the units expressing the variables mentioned, and the methods of measuring these variables, are explained below. The test specimens were prepared by injection molding using a Van Dorn 120HT Injection Molding Machine at a melt temperature of 200° C. and a mold cavity temperature of 27° C.
MFR [dg/min] Melt Flow Rate, reported as dg/min at 230° C., under a load of 2.16 kg, according to ASTM D-1238-01
Flexural modulus [MPa] Flexural Modulus, reported as mega-Pascals at 23° C. with a test speed of 2 mm/min and a test specimen of dimensions 4 ×10 ×80 mm, according to ISO 178 (2001)
Impact resistance [J/m] Izod Pendulum Impact Resistance, reported as J/m after at least 40 hours of conditioning at room temperature before and after notching, with a test specimen of dimensions ⅛″×½″×2.5″ and a 45° notch, according to Test Method A of ASTM D-256-00
Scratch on Surface As described in text, reported at 5N
Stress whitening Post-scratch test visual inspection of specimen at 5N; A: little or no stress whitening visible; B: moderate stress whitening; C: severe stress whitening
   Exemplary Materials Used in the Examples:
PP Polypropylene copolymer; Density: 0.905 g/cm³; MFR: 70 dg/min at 230° C. and 2.16 kg weight; Tg: 0° C.
Elastomer-1 Ethylene-based elastomer; Ethylene content: 42%; Density: 0.863 g/cm³; MI: 0.5 dg/min at 190° C. and 2.16 kg weight; Tg: −55° C.;
Elastomer-2 Styrene-based elastomer; Styrene content 12%; Specific Gravity: 0.89; MI: 4.5 dg/min at 230° C. and 2.16 kg weight; Tg: −60° C.
Elastomer-3 Styrene-based elastomer; Styrene content 18%; Specific Gravity: 0.89; MI: 4.5 dg/min at 230° C. and 2.16 kg weight; Tg: −60° C.
PBE Propylene-based elastomer; Density: 0.858 g/cm³; MFR: 2 dg/min at 230° C. and 2.16 kg weight; Tg: −31 ° C.
Additives Antioxidant, color concentrate, slip agent

The examples shown below were prepared in a Leistritz 27 mm co-rotating twin screw laboratory extruder Model TSE-27 with a length to diameter ratio (L/D) of 52. The extrusion temperature was 205° C., and the extruder speed was 400-450 rpm. Table 1 illustrates that a blend containing polypropylene and the propylene-based elastomer has good scratch resistance with little or no stress whitening. The balance of stiffness and impact resistance, however, could be improved. The addition of an ethylene-based elastomer in Comparative Ex. 2 improves the stiffness/impact balance, but the cost is an undesirable increase in stress whitening. Comparative Ex. 3, a polypropylene blend containing an ethylene-based elastomer and a styrene-based elastomer, also shows the same unacceptable increase in stress whitening.

TABLE 1

| | Comp. | Comp. | Comp. |
|---|---|---|---|
| | Ex. 1 | Ex. 2 | Ex. 3 |
| PP, wt % | 71.65 | 71.65 | 71.65 |
| PBE, wt % | 28 | 11 | — |
| Elastomer-1, wt % | — | 17 | 17 |
| Elastomer-3, wt % | — | — | 11 |
| Additive, wt % | 0.35 | 0.35 | 0.35 |
| MFR [dg/min] | 28.8 | 27.2 | 30 |
| Flex Modulus [MPa] | 926 | 998 | 1043 |
| Impact resistance @ RT [J/m] | 614 | 657 | 208 |
| Scratch on surface @ 5N | 1 | 1.5 | 1.5 |
| Stress whitening @ 5N | A | B | B |

Table 2 shows the surprising and unexpected results that occur when a styrene-based elastomer is added to a thermoplastic blend of a semi-crystalline polypropylene and a propylene-based elastomer. The combination of both a styrene-based elastomer and a propylene-based elastomer in the thermoplastic blend of the current invention improves the overall physical characteristics of the blend without significantly impairing the surface durability of the molded article made from the blend.

TABLE 2

| | Comp. | Comp. | | | |
|---|---|---|---|---|---|
| | Ex. 4 | Ex. 5 | Ex. 1 | Ex. 2 | Ex. 3 |
| PP, wt % | 72.5 | 72.5 | 72.5 | 72.5 | 72.5 |
| PBE, wt % | 24 | — | 6 | 12 | 18 |
| Elastomer-2, wt % | — | 24 | 18 | 12 | 6 |
| Additive, wt % | 3.5 | 3.5 | 3.5 | 3.5 | 3.5 |
| MFR [dg/min] | 35.1 | 33.6 | 34.6 | 34.4 | 34.3 |
| Flex Modulus [MPa] | 1007 | 764 | 793 | 862 | 942 |
| Impact resistance @ RM (J/m) | 573 | 725 | 725 | 691 | 647 |
| Scratch on surface @ 20N | 2.5 | 2.5 | 2.5 | 2.5 | 2.5 |
| Scratch on surface @ 5N | 1 | 1 | 1 | 1 | 1 |
| Stress whitening | A | A | A | A | A |

Examples 1-3 in Table 2 demonstrate the surprising and unexpected benefits of achieving minimal or no stress whitening even with a 3-polymer component blend according to the invention, particularly when viewed against the stress whitening that occurred with the 3-polymer component prior art formulations in Comparative Examples 2-3 in Table 1.

It is to be understood that the invention is not to be limited to the exact configuration as illustrated and described herein. Accordingly, all expedient modifications readily attainable by one of ordinary skill in the art from the disclosure set forth herein, or by routine experimentation therefrom, are deemed to be within the spirit and scope of the invention as defined by the appended claims.

What is claimed is:

1. A thermoplastic polyolefin blend having a rigidity and impact strength comprising:
a semi-crystalline polypropylene resin component in an amount sufficient to impart rigidity to the blend; and
an elastomeric component in an amount sufficient to impart impact strength to the blend and which comprises the combination of:
a propylene-based elastomer component having at least one isotactic polypropylene sequence and being present in an amount of at least about 0.1 weight percent to less than 40 weight percent based on the total weight of polymers in the blend, and
a styrene-based elastomer component present in an amount of at least about 0.1 weight percent of the blend.

2. The blend of claim 1, wherein the at least one semi-crystalline polypropylene resin component is present in an amount from about 1 to 99 weight percent, and the elastomeric component is present in an amount from about 1 to 99 weight percent, each based on the total weight of the polymers present in the blend.

3. The blend of claim 1, wherein the at least one semi-crystalline polypropylene resin component is present in an amount from about 20 to 95 weight percent, and the elastomeric component is present in an amount from about 5 to 80 weight percent, each based on the total weight of the polymers present in the blend.

4. The blend of claim 1, wherein the propylene-based elastomer component includes at least one of the following physical properties:
a) a plurality of identifying band positions at about 998 cm⁻¹, 974 cm⁻¹, and 733 cm⁻¹, as measured by Fourier Transform Infrared Spectroscopy (FTIR); or
b) one or more glass transition temperatures (Tg) from about −15° C. to −35° C., as measured by Differential Scanning Calorimetry (DSC).

5. The blend of claim 4, wherein the propylene-based elastomer component is a propylene/alpha-olefin copolymer or terpolymer with a propylene content of at least about 40 weight percent.

6. The blend of claim 4, wherein the propylene-based elastomer component is present in an amount of about 16 weight percent to 38 weight percent of the total weight of the polymers in the blend.

7. The blend of claim 4, wherein the propylene-based elastomer component has at least one of the following properties: a density typically ranging from about 0.858 to about 0.890 g/cm³, an overall crystallinity of about 3 to about 34%, or a weight average molecular weight (Mw) from about 50,000 to 400,000, or a combination thereof.

8. The blend of claim 1, wherein the styrene-based elastomer component is in the form of a block or random styrene copolymer that includes a styrenic component and a hydrogenated or non-hydrogenated olefinic component.

9. The blend of claim 8, wherein the styrene-based elastomer component is selectively hydrogenated, wherein at least about 80% of the double bonds in the hydrogenated olefinic component are hydrogenated, and wherein less than about 65% of the double bonds of the styrenic component are hydrogenated.

10. The blend of claim 8, wherein the styrene-based elastomer component comprises styrene-ethylene/butylene, styrene-ethylene/butylene-styrene, styrene-ethylene/propylene-styrene, styrene-butadiene, styrene-butadiene-styrene, styrene-butylene-styrene, styrene-butylene-butadiene-styrene, styrene-isoprene-styrene, or a blend thereof.

11. The blend of claim 1, wherein the semi-crystalline polypropylene resin component comprises one or more homopolymers of propylene, copolymers of at least 50 weight percent propylene and at least one other C₂ to C₂₀ alpha-olefin, or mixtures thereof, and is present in an amount of between about 30 to 90 weight percent based on the total weight of the polymers present in the blend.

12. The blend of claim 1, further comprising high density polyethylene or low density polyethylene that is present in an amount sufficient to enhance the toughness of the blend and up to about 25 weight percent of the total weight of polymers in the blend.

13. The blend of claim 1, further comprising one or more thermal stabilizers, ultraviolet stabilizers, flame retardants, mineral fillers, process oils, conductive fillers, nucleating agents, plasticizers, impact modifiers, colorants, mold release agents, lubricants, antistatic agents, pigments, or a combination thereof.

14. The blend of claim 3, wherein the propylene-based elastomer component is present in an amount greater than 15 weight percent of the total weight of the polymers present in the overall blend, and the styrene-based elastomer component is present in an amount of less than 75 weight percent of the total weight of the polymers present in the overall blend.

15. The blend of claim 1, wherein the styrene-based elastomer component has at least one glass transition temperature (Tg) from about −40° C. to −60° C., as measured by DSC.

16. The blend of claim 1, wherein the semi-crystalline polypropylene resin component has at least one glass transition temperature from about −10° C. to about 5° C., as measured by DSC.

17. A molded article comprising the blend of claim 1.

18. The article of claim 17 wherein the blend further comprises one or more thermal stabilizers, ultraviolet stabilizers, flame retardants, mineral fillers, process oils, conductive fillers, nucleating agents, plasticizers, impact modifiers, colorants, mold release agents, lubricants, antistatic agents, pigments, or a combination thereof.

19. An extruded article comprising the blend of claim 1.

20. The article of claim 19 wherein the blend further comprises one or more thermal stabilizers, ultraviolet stabilizers, flame retardants, mineral fillers, process oils, conductive fillers, nucleating agents, plasticizers, impact modifiers, colorants, mold release agents, lubricants, antistatic agents, pigments, or a combination thereof.
